(19) United States
(12) Patent Application Publication
(10) Pub. No.: US 2005/0151391 A1
(43) Pub. Date: Jul. 14, 2005

(54) Protective vehicle cover

(76) Inventor: Randall R. Bryd, Redding, CA (US)

Correspondence Address: EDWARD S. SHERMAN, ESQ., 3554 ROUND BARN BLVD., SUITE 303, SANTA ROSA, CA, 95403, US

(21) Appl. No.: 10/757,640

(22) Filed: Jan. 13, 2004

(51) Int. Cl. B60J 11/00

(52) U.S. Cl. 296/136.1

(57) ABSTRACT

A protective cover for vehicles is configured to fully protect a vehicle from paint overspray, yet avoids surfaces scratches induced by existing debris. An elastic band having a high stretch ratio aids in both cover placement and reduce movement to further minimize risk of damage to painted surface. The protective cover is preferably fabricated from thin gauge transparent plastic sheeting; such that the low cost makes the product desirable as it can be disposed of after being contaminated by a single use.

### CROSS REFERENCE TO RELATED APPLICATIONS

The present applications claims priority from the provisional patent application entitled “A Protective Vehicle Cover”, filed on Jan. 16, 2003, having Ser. No. 60/440,815, which is incorporated herein by reference

### BACKGROUND OF INVENTION

This invention relates generally to the field of protective covers for vehicles, and more particularly a disposable cover to protect vehicles from paint overspray and aggressive or abrasive particulate while parked or stored.

A drape type or non-rigid cover for the temporary protection of vehicles is well known, employing different configurations depending on the conditions and time of use. Frequently, new automobiles are covered at the factory so that they can be driven onto car transport vehicles or ships, and then removed by driving off. Such covers require an opening for the driver, as well as transparent covering over the windows and must not otherwise interfere with the operation of the vehicle.

Alternatively, some consumers cover new or expensive cars with sewn fabric covers to protect the finish from ultraviolet exposure from the sunlight, severe weather conditions or damage from occasional contact with the doors of nearby vehicles.

in order to facilitate either the operation of the car with a protective cover and place, or the simplicity of fitting a protective cover to a car or other vehicle, drape type covers are frequently fabricated from multiple panels or pieces of fabric so as to fully conform to the shape of a particular vehicle.

Further, durable fabric is frequently used to enhance the protection from mechanical damage, and extend the life of such a relatively expensive cover.

While a number of cover designs have been developed for both industrial and consumer use, they suffer several deficiencies when the objective is to provide temporary protection of vehicles from paint overspray, or exposure to aggressive particulate contaminants in a local environment.

Spray painting operations present to particular hazards to the finishes of nearby vehicles. Of primary concern is the liquid or sticky form of the aerosol particles, which readily adhere to the outer layer of a typical automotive paint finish, as well as other portions of a vehicle's exposed surfaces.

Since the dry aerosol is also inherent paint, it is difficult to remove without damaging the finish. Further, these dry aerosol particles are particularly abrasive with respect to an automotive finish. This is a particular problem in an automobile paint shop, where the newly painted surfaces are delicate, yet there is a considerable amount of the dry aerosol in the environment.

Additionally, spray painting of the exterior buildings presents the same hazards to cars parked in the vicinity of the building. Absent a means to protect each parked vehicle, the painting contractor must either clear the parking lot of automobiles, which requires securing the site the evening before, or require each tenant to move their vehicle.

However, covering automobiles parked in the vicinity of the building has been unattractive for a number of reasons. One is the expense of conventional protective covers for automobiles. In addition to taking considerable time to properly fit on parked cars, they do not offer very good protection from the dry aerosol particulate, which is readily disbursed by light wind and vehicle traffic, readily penetrates between the covering the automobile finish.

In fact for the most durable covers, being heavier weight, frequently exacerbate the potential abrasion from pre-existing particulate, such as the degradation byproducts of the existing paint, via the frictional force exerted by the cover on the particulate matter. This is particularly noticeable on automobiles having dark colors.

Further, as the dry form of the aerosol particulate has a strong tendency to accumulate on these covers, and spread from the outside to the insider during folding and storage, generally expensive car covers would need to be to be replaced frequently.

Ordinary plastic sheeting is generally not an attractive option. Although it would appear easy to install on automobiles, it takes considerable time and effort to securely attach the plastic sheeting, as it is easily dislodged by wind.

Accordingly, there is a need for a temporary vehicle cover suitable to protect from paint overspray and related environmental hazards.

There is a further need for such a temporary cover that is immediately fitted in a secure manner to a wide range of vehicles, yet at a low cost so that it may be disposed of after a single use.

Further, there is a need for such a temporary protective cover that does not cause additional damage to automobiles by the abrasive action of other environmental agents with the surface during installation, use or removal of the protective cover.

### SUMMARY OF INVENTION

A thin sheet of a flexible material takes the general form of a mushroom cap in response to the force of the retracted elastic band attached to the sheets perimeter. The sheet is then employed as a protective cover, as it is readily attached and secured to completely protect the vehicle against unwanted dust from construction, chemicals and harmful deposits, sawdust and general construction, overspray, latex and oil based paint, solvents, and the like.

As the elastic band is attached to the sheet perimeter in a stretched condition the cover usually has an opening at the bottom slightly smaller than the perimeter defined by the wheels of the automobile or vehicle. This protective cover is readily installed over the vehicle by first stretching the elastic band to enlarge the opening, pulling the opening from the front or first end of the vehicle to the opposite end. The protective cover is then secured by placing the elastic band around the tires such that it remains in place under various weather conditions, the extended dimensions of the sheet being sized to fully protect the entire vehicle. The protective cover preferably deploys an elastic material having a stretch ratio of about 2 to 1, or greater, to accommodate a wide range of vehicle types, this minimizes the number of discrete size the merchant or contractor requires in stock.

In selected embodiments the sheet used to form the protective cover is a thin plastic film, as such a construction avoids both the damage from pre-existing contaminants, yet is of a sufficiently low cost to be disposed of and recycled after a single use.

In another embodiment the plastic sheet is preferably transparent so is not to secure the vehicles identity.

Accordingly, various embodiments of the inventive cover may be deployed in long term airport parking, park and ride, car dealerships, auto body shops or anywhere complete overspray and environmental protection is desired, or even to protect from and more substantial, and hence expensive custom cover.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a perspective view of the inventive protective cover 100 installed on a motor vehicle 110.

FIG. 2 is a plan view of the sheet used to form the protective cover prior to attachment of the elastic band on its perimeter.

FIGS. 3A and 3B are elevation and plan views respectively of a sedan type vehicle illustrating the optimum sizing of the sheet shown in FIG. 2.

FIG. 4 is a cross-sectional diagram of an elevation of a vehicle illustrating beneficial features of a preferred embodiment of a light weight protective cover installed thereon

FIGS. 5A and 5B are elevation and plan views of a sport utility vehicle (SUV) or Van type vehicle illustrating the optimum sizing of the sheet shown used to form a preferred protective cover.

FIG. 6 is a plan view of an alternative embodiment of a sheet used to form the protective cover prior to attachment of the elastic band on its perimeter.

### DETAILED DESCRIPTION

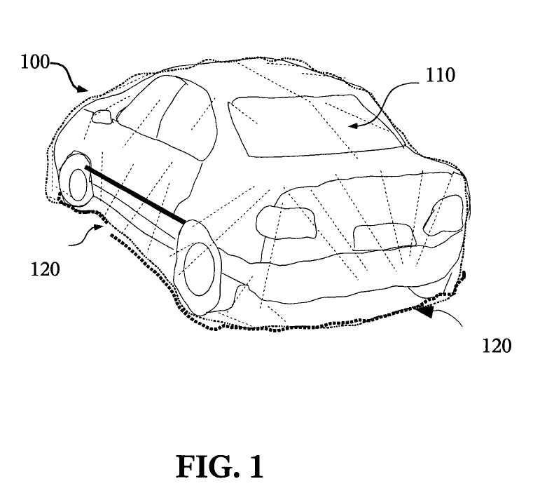

In accordance with the present invention, FIG. 1 shows this inventive protective cover 100 installed on a motor vehicle 110. The cover is installed by an individual by starting at a first end of the vehicle by stretching the elastic band to enlarge the opening, then uniformly working the opening to the opposite end of the vehicle before placing the elastic band around the lower portions of the tires, thus bringing portions of the protective cover around the underside of the vehicle. Frequently, the most antenna structures can be left in place. Thus protective vehicle cover 100 is preferably fabricated from a single discrete sheet, as the outer dimension and elastic band properties provide a cover that substantially surrounds the entire vehicle. When installed the opening at elastic band 120 is at the ground level where the sheet closes around a perimeter region preferably having outer dimensions corresponding substantially to point of contact of the outside edge of each of the four tires with the ground.

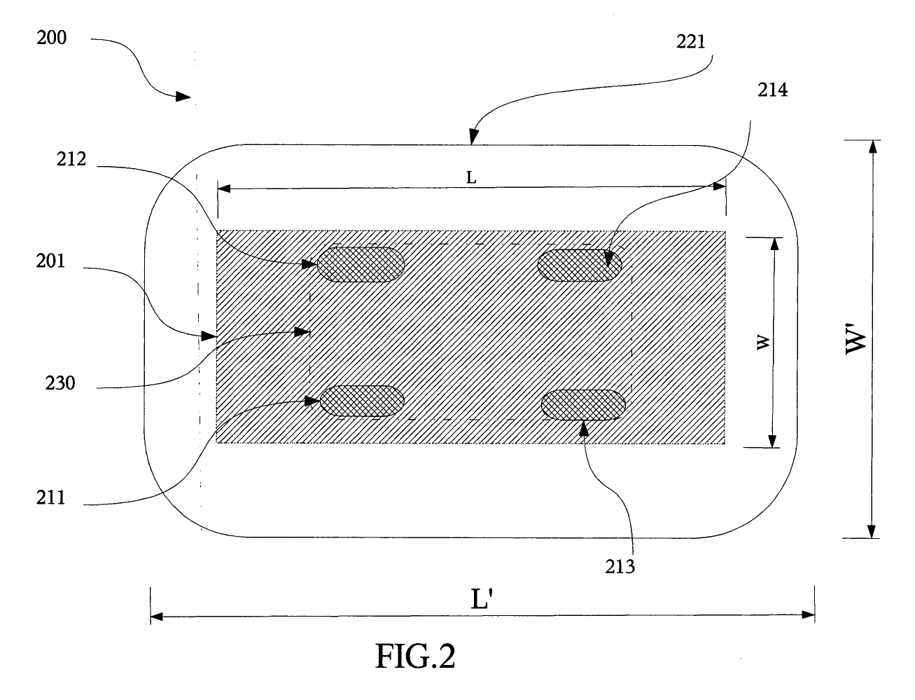

In accordance with an important feature of the present invention, there is shown in FIG. 2, a plan view of an embodiment of the protective cover prior to attachment of the elastic fabric onto perimeter 201 of sheet 200. The sheet is preferentially rectangular in shape and has rounded corners, and may approach an oval form. Owing to the great variability in the range of commercially consumer vehicles the protective covers preferably fabricated in a selected range of discrete sizes. However, a more preferred embodiment enables limiting the number of discrete sizes, minimizing the stock variety of merchant or paint-contractor-would need to have on hand.

FIG. 2 is a plan view to illustrate some of the vehicle dimensions used optimizes the dimensions of the sheet used to form the protective cover.

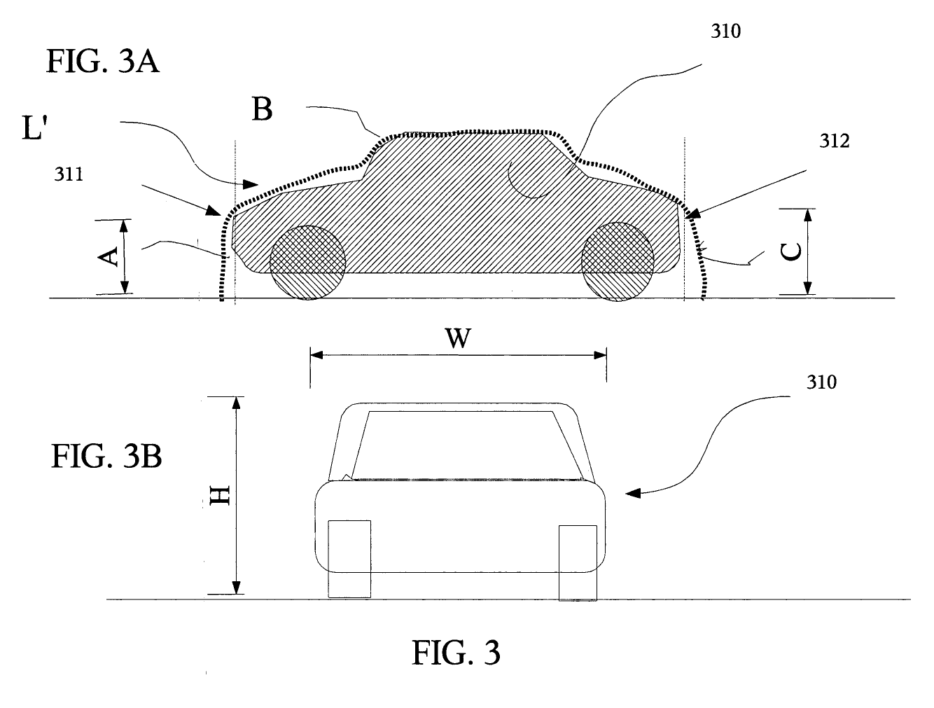

FIGS. 3A and 3B are cross-sections of the vehicle taken at the lines 3A-3A′ and 3B-3B′ as shown in the horizontal projection of the vehicle dimensions in FIG. 2.

Thus FIGS. 2 and 3 help illustrate design principles useful to either limit the number of discrete sizes required, determine a preferred elastic ratio for the material used to form the band, or optimize the fit for particular vehicle size, by taking into account the width, height, body curvature and wheel base dimensions of the vehicle. In these figures primed letters, for example W′ and L′, refer to the sheet dimension whereas unprimed letters in these figures refer to the associated dimensions of the vehicle.

FIG. 2 is a plan view of showing the relationship of the vehicle 210 dimensions to the sheet 200 dimension so as to fully optimize the sheet to protect a wider range of vehicle sizes. Line 201 represents the horizontal projection of the outer surfaces of vehicle 210 in the plane of the Figure. Vehicle 210 has four tires labeled 211, 212, 213 and 214.

As the elastic band is stretched at the time of attachment to the perimeter of sheet 200 the relaxed around strain dimension is preferably smaller than the perimeter defined by reference rectangle 230. Rectangle 230 corresponds to the ideal conforming dimensions of the elastic band in the installed position, comprising forth linear segments that circumscribe points defined by intersections of the outward facing edges of the four tires with the ground.

Thus the elastic fabric or band retains the cover in place securely around the tires or other lower portions of the vehicle 210 under the frame. When the strain ratio of the elastic fabric is higher than about 2.5 the gripping force and friction of the elastic fabric around the tires or lower portions of the car body is sufficient to prevent a strong wind from lifting the cover off the vehicle. However, in some locales it may be desirable to use a heavier weight elastic fabric band or other material to further enhance the stability of the cover.

Accordingly, the outer sheet dimensions W′ and L′ of sheet 200 are selected to fully exploit the high elastic strain ratio of the elastic band that will be secured or stitched to the sheet perimeter 221 such that a broad range of vehicles can be fully protected with a single protective cover size. Sheet 200 must extend beyond the right and left sides of vehicle 210, defined by projected rectangle 201, a sufficient distance to accommodate the vehicles height, H, shown in FIG. 3B. This permits the elastic band to extend downward to reach ground and thus retract towards the approximate dimensions defined by rectangle 230 In FIG. 2.

Thus sheet 200 has a length, L′, preferably equal to at least the sum of the vehicle length, L, with twice the height of the vehicle, H:
L′=2×H+W, (equation 1)

Likewise the other sheet dimension, W′ is preferably equal to at least the sum of the vehicle length, L, with twice the height of the vehicle, H:
W′=2×H+W, (equation 2)

Ultimately, the length of the sheet, L′, can usually be reduced further depending on the curvature of the vehicle surface in the direction of travel.

However, the ultimate selection of the length of sheet 200 sheet also take into account the displacement of the tires from the edge of the vehicle is defined by perimeter 201.

Accordingly, a starting point for determination of a more preferred length L′ of sheet 200 requires consideration of the vehicle curvature as illustrated in FIG. 3A by an arc having three segments labeled as A, B and C. The central segment of this arc, B, follows the roof, hood and trunk contours of the vehicle in the direction of travel, starting at a point indicated by the arrow having the number 311 and terminating at a point indicated by another arrow having a number 312. These points indicated by arrow's 311 and 312 represent the position along the vehicles contour where an unconstrained fabric segment would drape in the vertical direction until reaching the ground. Thus the remaining segments, A and C, are at least equal to about the distance from the vertical distance from the drape point to the ground. Thus depending on the set back of tires 211 and 212 from the respective front and rear edges of vehicle 210, L′ is equal to at least about the sum arc segment lengths A, B and C.

Therefore an approximate lower limit for the stretch ratio of the elastic band can be determined by the dimensions of the vehicle and the minimal covering sheet is defined in FIGS. 2 and 3 according to equations 1 and 2. The stretch ratio of the sheet is preferably the ratio between the perimeter 221 of sheet 200 divided by the perimeter of rectangle 230. It should be apparent that providing an elastic fabric with a higher stretch will accommodate a wider range of vehicle sizes with complete coverage from paint overspray.

While the protective cover can also be fabricated from lightweight fabrics, including non-woven fabrics formed from polyolefin fibers, plastic sheeting is preferred as a low cost material that is substantially transparent so that vehicle owners can readily identify their cars.

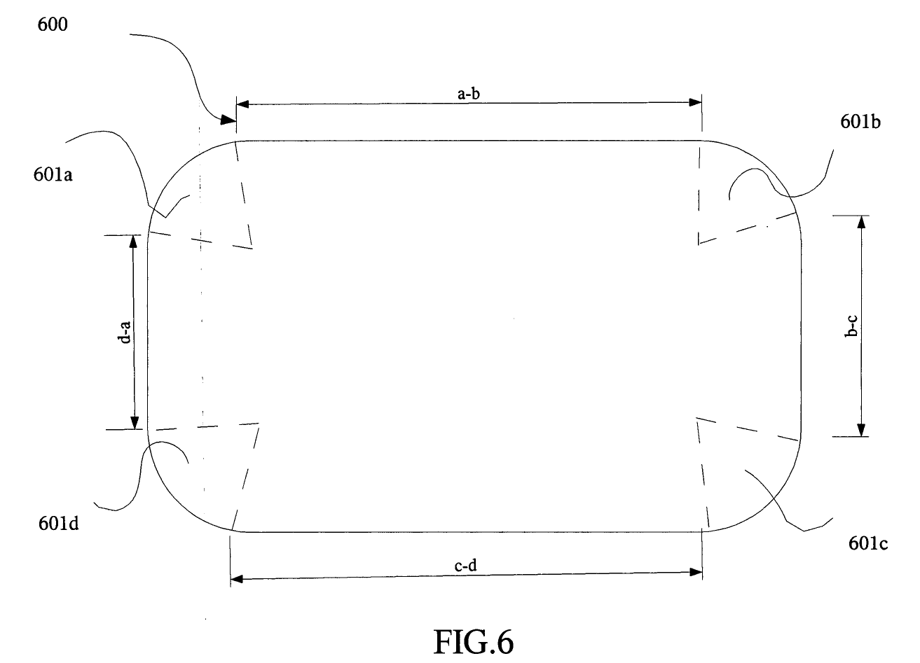

The protective cover can be fabricated from either a monolithic sheet or a sheet formed by sewing, stitching, taping, heat sealing or ultrasonic welding together of narrower sheets. Alternatively, the sheet need not be planar before attaching the elastic band at the perimeter. To the extend that a larger stretch ratio elastic is deployed it may be preferable to remove v-shaped segment form the 4 corners of the sheet as shown in FIG. 6, thus eliminating an excess of material from interfering with installation or adding bulk and weight to the packaging. In FIG. 6 panels 601a, b, c and d are removed from planar sheet 600 by cutting along the dashed lines that form a v-shape at each corner. The four pairs of 2 facing cut edges corresponding to removed segments 601a, b, c and d are then connected by either sewing, stitching, taping, heat sealing ultrasonic welding, and the like, such that the planar sheet distorts to a concave shape wherein the elastic band is attached to the now shorter length perimeter, defined by the sum of linear segments a-b, b-c, c-d and d-e.

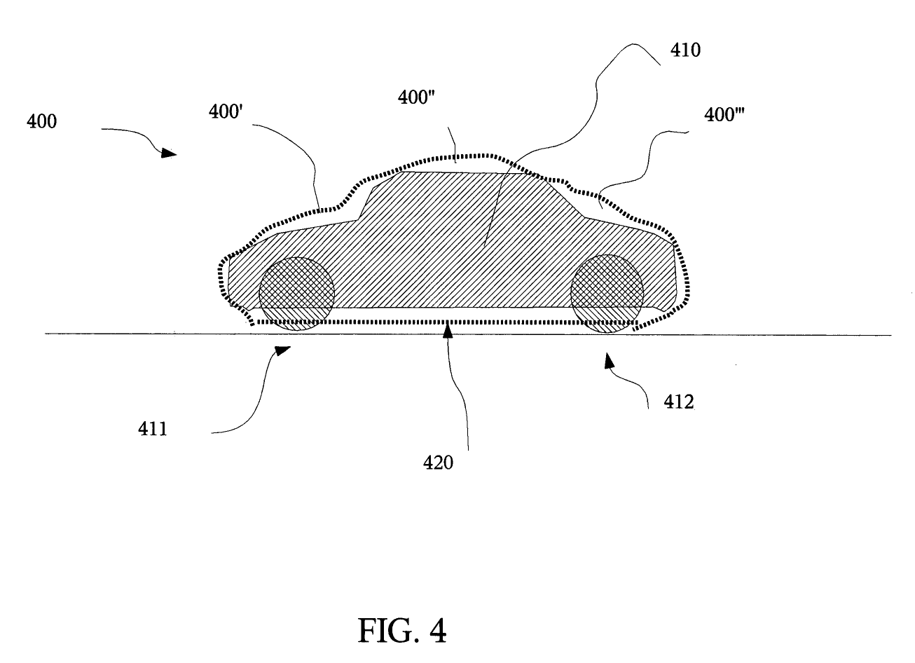

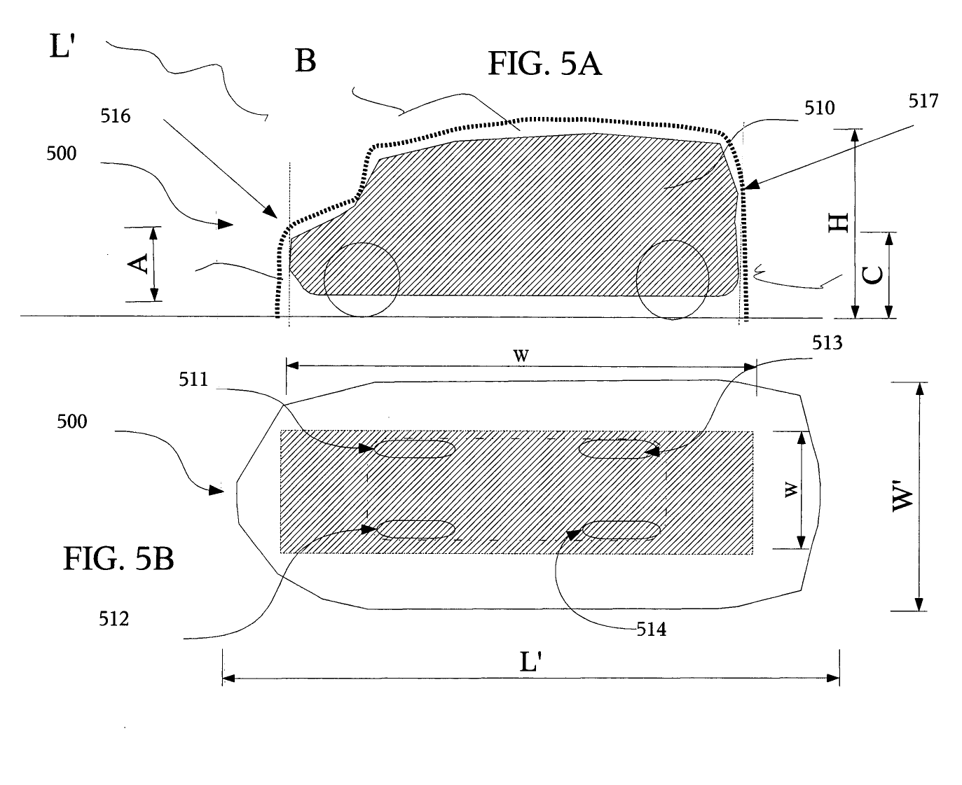

It will be apparent to one of ordinary skill in the art that sheet 200 in FIG. 2 need not have rounded corners or linear parallel sides and can be asymmetrical in corner curvature at the front and rear of the vehicle so as to accommodate station wagons, vans, sport utility vehicles, pick-up trucks and a host of other commercial vehicles. Indeed, as shown in FIG. 5A (elevation) and 5B (plan), in the case of a protective cover for vehicles that do not conform to the body curvature of conventional car in FIG. 4, the corners of protective sheet 500 that correspond to the front of vehicle, circa reference arrow 516, can have a greater curvature with respect to the corners disposed at the other end of sheet 500. Vehicle 510 has four tires labeled 511, 512, 513 and 514.

A starting point for determination of a more preferred length L′ of sheet 500 requires consideration of the vehicle curvature as illustrated in FIG. 5A by an arc having three segments labeled as A, B and C. The central segment of this arc, B, follows the front hood and roof contours of the vehicle in the direction of travel, starting at a point indicated by the arrow having the number 516 and terminating at a point indicated by another arrow having a number 517. These points indicated by arrow's 516 and 517 represent the position along the vehicles contour where an unconstrained fabric segment would drape in the vertical direction until reaching the ground. Thus the remaining segments, A and C, are at least equal to about the distance from the vertical distance from the drape point to the ground. Thus depending on the set back of tires 511 and 513 from the respective front and rear edges of vehicle 510, L′ is equal to at least about the sum arc segment lengths A, B and C. Generally the rear of corners of sheet 500, corresponding to the back of the vehicle circa arrow 517, will have an optimum radius of curvature at a somewhat less than that preferred for the conventional sedan in FIG. 3.

FIG. 4 is a cross-sectional diagram of an elevation of a vehicle schematically illustrating the substantial displacement a relatively light weight and air impermeable sheet will make from the vehicle service undermost conditions of use. That is the outer surface of vehicle 410 is generally not in contact with the majority of the interior surface off protective cover 410 in extremely light wind, such as that produced from nearby vehicular traffic, Impinging air readily enters under the cover 400 at or below elastic fabric perimeter 420 as the placement of elastic band near the ground sufficiently blocks most of the impinging air such that some enters below the elastic band and suspends the light weight found away from the vehicle finish, typically at locations indicated by arrows 400′, 400″ and 400′″. This suspension of the light film above the automobile surface helps prevent the abrasive damage by the particulate contamination present on the car surface prior to installation of the cover, or that enters under the protective cover.

Thus, having discovered that a light weight sheet with readily billow up with either a mild breeze or even the expansion of air as it is heated by the sun under the cover, it can be appreciated that the elastic fabric need not fully exclude the atmosphere to avoid abrasion of the car finish, as even pre-existing particulate is not a hazard where contact with the light weight cover is avoided. Further, the lower masses of the cover largely precludes any abrasion at the limited contact point, as the potential frictional forces are reduced, as well as the exclusion of new contaminants from entering these contact areas.

It should be appreciated that the plastic sheet is then preferably as light as possible, and hence thin, to fully exploit the billowing characteristic, as it substantially avoid the marrying of a car finish, contrary to the performance of the heavier, and more durable permanent covers.

Accordingly, the flexible sheet is preferably and air impermeable plastic film, rather than fabric, and is more preferably constructed of a strong pay a resistant plastic low cost, such as a polyethylene, including but not limited to low density polyethylene film, linear low density polyethylene film and the like.

Although, the preferred thickness of a plastic sheet or film will depend of the relative strength of the film material selected for the cover, most polyethylene films will have sufficient strength at about 1 mil thickness. However about a 0.5 mil thickness is preferred to reduce cost and offer greater abrasion protection to an unwashed vehicle that has pre-existing particulate contamination on its surface.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A vehicle protective cover comprising:
a) a flexible sheet;
b) elastic fabric disposed on the perimeter of the plastic sheet; and
wherein said elastic fabric has a stretch ratio of at least about 2 to 1.

2. A vehicle protective cover as claimed in claim 1 wherein said flexible sheet is a substantially transparent plastic having a thickness of less than about 1 mil.

3. A vehicle protective cover as claimed in claim 1 wherein said elastic fabric has a stretch ratio of at least about 2.5 to 1.

4. A vehicle protective cover as claimed in claim 3 wherein said elastic fabric has a stretch ratio of at least about 3 to 1.

5. A vehicle protective cover as claimed in claim 1 wherein said flexible sheet has a thickness of less than about 1 mil.

6. A vehicle protective cover as claimed in claim 1 wherein said flexible sheet has a thickness of less than about 2 mils.

7. A vehicle protective cover as claimed in claim 1 wherein said flexible sheet has a thickness of less than about 5 mils.

8. A vehicle protective cover as claimed in claim 1 wherein the flexible sheet is a lightweight fabric.

9. A vehicle protective cover as claimed in claim 8 wherein the flexible sheet is a non-woven fabric.

10. A vehicle protective cover as claimed in claim 9 wherein the flexible sheet is formed from polyolefin fibers.

11. A vehicle protective cover as claimed in claim 1 wherein the flexible sheet is substantially transparent.

12. A vehicle protective cover as claimed in claim 1 wherein the flexible sheet is formed by a method selected from the group consisting of sewing, stitching, taping, heat sealing and ultrasonic welding together of narrower sheets.

13. A vehicle protective cover as claimed in claim 1 wherein the flexible sheet is formed from a first sheet by;
a) removing a plurality of V-shaped,
b) attaching the edges of the V-shaped section to form a second, non planar sheet,
c) attached the elastic fabric about the perimeter of the second sheet.

14. A vehicle protective cover as claimed in claim 13 wherein the first sheet is trimmed to define the perimeter of the second non-planar sheet before the V-shaped section are removed therefrom.
